(19) United States
(12) Patent Application Publication
(10) Pub. No.: US 2002/0185533 A1
(43) Pub. Date: Dec. 12, 2002

(54) Externally connection type USB2.0 interface flash card reader

(76) Inventors: Ron-Yen Shieh, Taipei (TW); Gorden Tsai, Taipei Hsien (TW); Yen-Ann Chen, Taipei (TW); Chung-Lin Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/874,303

(22) Filed: Jun. 6, 2001

(51) Int. Cl. G06K 7/06

(52) U.S. Cl. 235/441

(57) ABSTRACT

An externally connection type USB2.0 interface flash card reader comprising an insertion cassette housing, and a USB2.0 connection cable, characterized in that one end of the insertion cassette housing is provided with an insertion/connection hole allowing the insertion of various type of solid state flash cards externally to the insertion cassette housing, and connecting to USB ports of a host computer via the USB 2.0 card.

### BACKGROUND OF THE INVENTION

(a) Field of the Invention

The present invention relates to an externally connection USB2.0 interface flash card reader, and in particular, a flash card reader having an insertion cassette housing, a USB2.0 connector and data transmission circuit. The reader can be connected to host computers having conventional USB1.1 or USB1.0 format to execute data transmission of USB1.1/1.0 transmission speed.

(b) Description of the Prior Art

For connecting computer peripheral equipments to a computer, there are various kind of connection specification, such as COM1, COM2, PARALLEL/PRINTER port, SCS1 with various PIN number transmission connector, as a result, users may mistakenly connect the peripheral equipment to a wrong connection on the computer.

USB 1.0/1.1 connection is developed by some of the computer manufacturers such as COMPAQ, DEC, IBM, INTEL, MICROSOFT, etc. in the hope that the USB 1.0/1.1 interface can be used to replace the conventional interface. However, USB 1.0/1.1 interface is only applicable in 1 Mbit to 12 Mbit computer peripheral equipments, such as the keyboard, the mouse, etc. Currently the flash card readers are normally parallel ports or USB 1.0/1.1 interface and the fastest speed is 1.5 MB/Sec (12 Mbit/Sec), and the interface of USB2.0 can reach a speed of 60 MB/Sec (480 Mbit/Sec), which is about 40 times of the USB1.0/1.1, and the speed has been upgraded significantly. Furthermore, the flash memory is applied to various digital product and the capacity and the transmission speed can be upgraded at a fast pace. Therefore, USB2.0 interface reader will be an important product in the digital products market.

### SUMMARY OF THE INVENTION

Accordingly, it is an objective of the present invention to provide externally connection type USB2.0 interface flash card reader, wherein a USB2.0 connection cable or connector is provided to directly insert into USB ports of the computer, an insertion/connection port provided thereto allows the mounting of a solid state flash card to the insertion housing to proceed with the reading and writing of the externally connected memory card so that the computer having USB interface can proceed the high speed transmission of the data and program stored in the externally connected flash memory card.

Yet another objective of the present invention is to provide an externally connection type USB2.0 interface flash card reader comprising an insertion cassette housing, and a USB2.0 connection cable, characterized in that one end of the insertion cassette housing is provided with an opening allowing the insertion of various type of solid state flash cards and connecting to USB ports of a host computer via the USB 2.0 interface.

The foregoing objectives and summary provide only a brief introduction to the present invention. To fully appreciate these and other objectives of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a perspective view of the externally connected USB 2.0 interface flash card reader of the present invention, wherein the USB2.0 cable is connected to the interior of the insertion cassette housing.

FIG. 2 shows a perspective view of the externally connected USB 2.0 interface flash card reader of the present invention, wherein the cable connection method is standard USB2.0 cable which is detachable from the insertion cassette housing.

FIG. 3 shows a perspective view of the externally connected USB 2.0 interface flash card reader of the present invention, wherein the connection method is that the reader is directly connected to USB ports of the host computer.

FIG. 4 shows the circuit of the externally connected USB 2.0 interface flash card reader of the present invention, wherein the connection of the reader that the USB2.0 connector is directly soldered to the PCB of the insertion cassette housing.

FIG. 5 shows the block diagram of the action of the externally connected USB 2.0 interface flash card reader of the present invention.

FIG. 6 is another preferred embodiment of the circuit of the externally connected USB 2.0 interface flash card reader of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

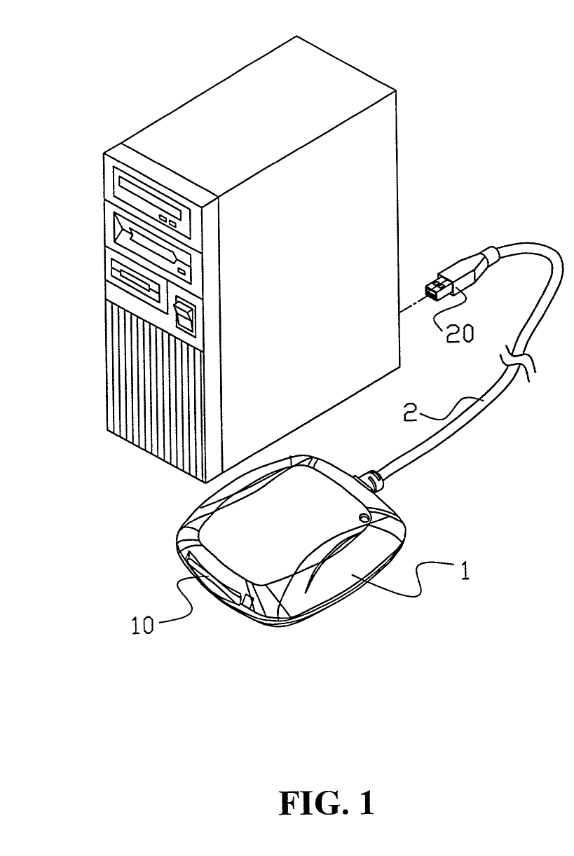

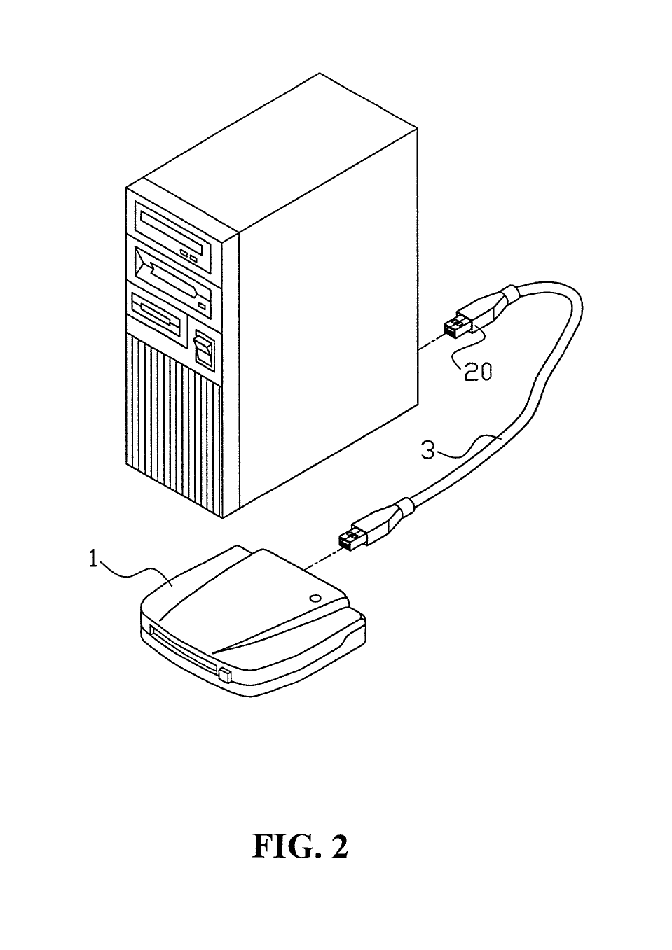

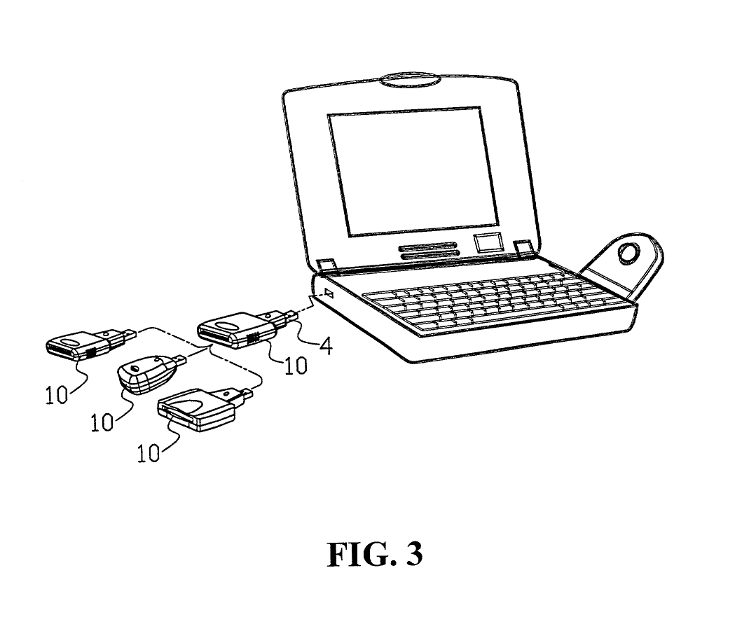

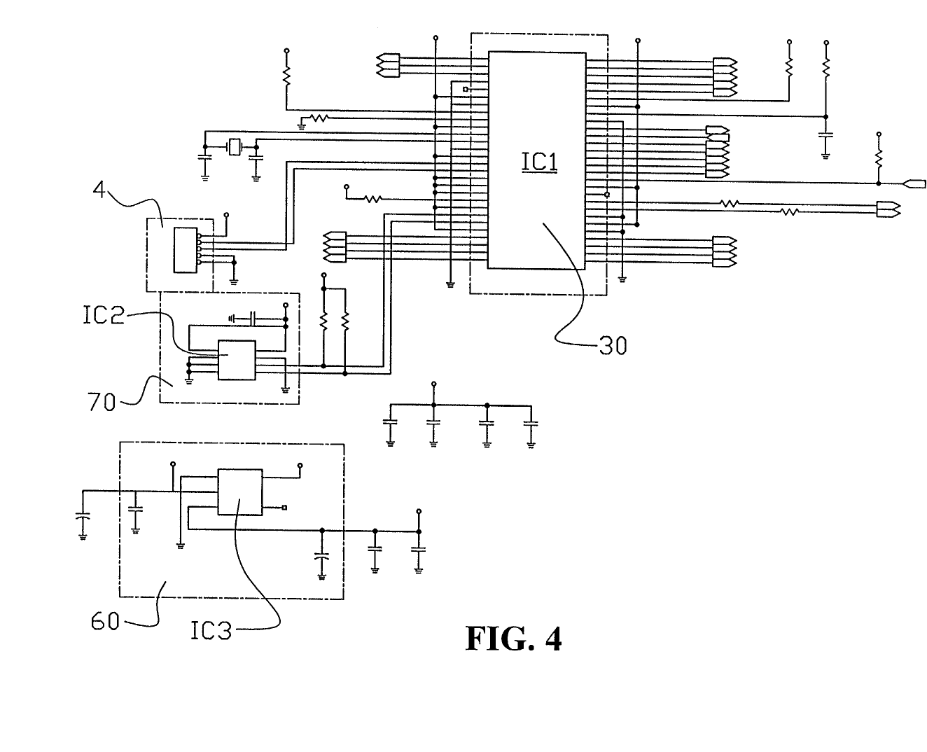

FIG. 1 is a perspective view of the externally connection type flash card reader suitable for use with USB2.0 or 1/1/1.0 format. As shown in the figure, there is shown an insertion cassette housing 1 having a USB 2.0 connection cable 2 extended from the end terminal of the insertion cassette housing 1. One end of the insertion cassette housing 1 is provided with a flash card insertion port 10 for the insertion of a flash card or/and various types of externally connected memory cards to the interior of the insertion cassette housing. The USB 2.0 connection cable 2 is provided with an USB connection terminal 20 which can be inserted to the USB ports of the host computer. FIG. 2 shows the flash memory card reader, wherein the method of cable connection is standard USB2.0 cable which can be detached from the insertion cassette housing. FIG. 3 shows the flash memory card reader, which can directly connect to the USB port of the host computer without connection by a connection cable. FIG. 4 shows the USB2.0 interface flash memory card reader, wherein the USB2.0 connector 4 is directly soldered onto the circuit of the PC board, and the PC circuit is mounted with a USB 2.0 controller 30, serial EEPROM 70 and a voltage regulator 60.

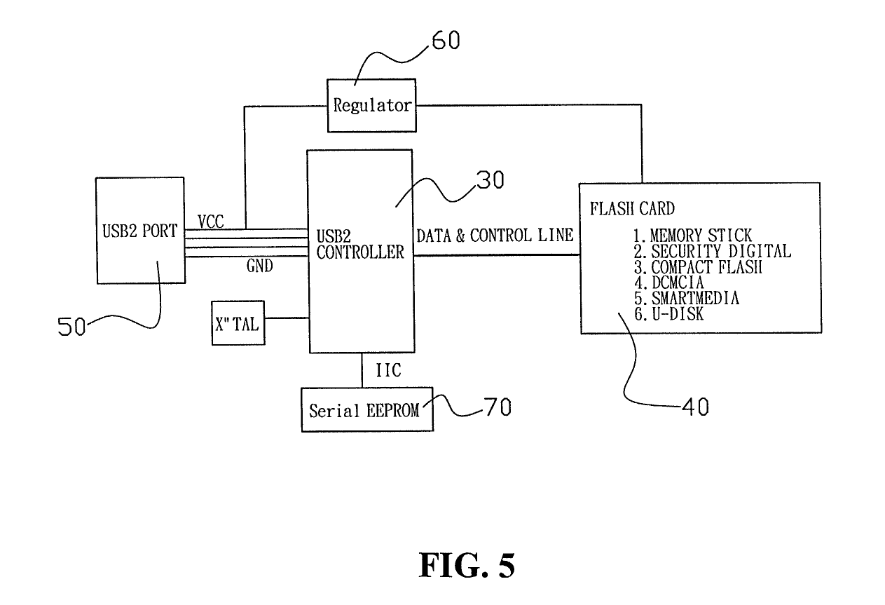

Referring to FIG. 5, there is shown a block diagram of the action of the card reader of the present invention. The flash card reader has the USB2.0 controller 30, and one end of the controller 30 receives and controls transmission data of the externally connection type flash memory card 40 (for example SSFDC, PCMCIA, FLASH (PCMCIA interface flash memory card and harddrive card), CompactFlash (compactflash memory card containing harddrive card), MMC (MultiMedia Card), SD (Secure Digital), Memory Stick, and UDISK) and transmits to USB2.0 connection port 50. A serial EEPROM 70 connects to the USB2.0 controller 30, and the voltage regulator 60 regulates the required voltage of the USB2.0 connection port 50 to the externally connection type flash memory card 40.

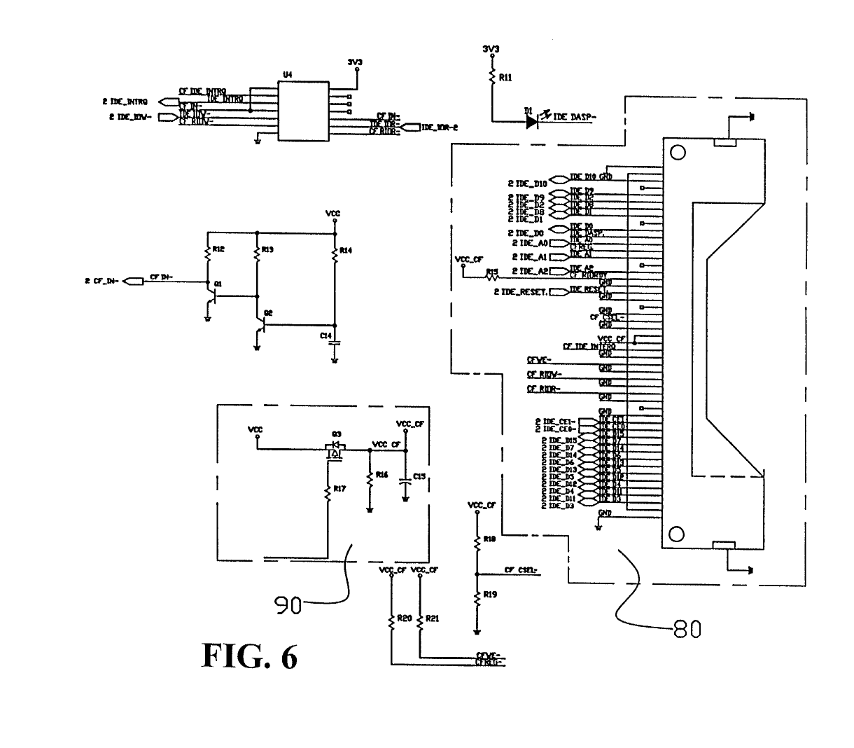

FIG. 6 is a circuit diagram in accordance of the present invention. As shown in the figure a CF connector 80, a power source MOSFET switch 90 are provided such that the function of the reader is more complete.

In view of the above, the present externally connection type USB2.0 interface flash card reader provides rapid transmission characteristics for computers, with USB 1.0/1.1 format or new USB2.0 format to proceed with the connection and transmission with externally connected flash cards, including SSFDC (SmartMedia) format, PCMCIA format, COMPACTFLASH format, MMC, SD, Memory Stick and UDISK format.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An externally connection type USB2.0 interface flash card reader comprising an insertion cassette housing, and a USB2.0 connection cable, characterized in that one end of the insertion cassette housing is provided with an insertion/connection hole allowing the insertion of various type of solid state flash cards externally to the insertion cassette housing, and connecting to USB ports of a host computer via the USB 2.0 interface.

2. The externally connection type USB2.0 interface flash card reader of claim 1, wherein the connection of the reader with the host computer is by direct mounting of the USB connector soldered on the PCB within the insertion cassette housing onto the USB ports of the host computer.

3. The externally connection type USB2.0 interface flash card reader of claim 1, wherein the reader is mounted with the host computer by a detachably USB2.0 cable connection.

4. The externally connection type USB2.0 interface flash card reader of claim 1, wherein the reader is connected to the USB ports of the host computer by the USB connection cable terminal.

5. The externally connection type USB2.0 interface flash card reader of claim 1, wherein the flash memory cards are compactflash card.

6. The externally connection type USB2.0 interface flash card reader of claim 1, wherein the memory format is SSFDC (SmartMedia).

7. The externally connection type USB2.0 interface flash card reader of claim 1, wherein the appropriate flash memory card format is PCMCIA.

8. The externally connection type USB2.0 interface flash card reader of claim 1, wherein the appropriate flash memory card format is MMC (MultiMedia Card).

9. The externally connection type USB2.0 interface flash card reader of claim 1, wherein the appropriate flash memory card format is SD (Secure Digital).

10. The externally connection type USB2.0 interface flash card reader of claim 1, wherein the appropriate flash memory card format is memory stick flash card.

11. The externally connection type USB2.0 interface flash card reader of claim 1, wherein the appropriate flash memory card format is UDISK.

12. The externally connection type USB2.0 interface flash card reader of claim 1, wherein the flash memory insertion/connection port is provided with at least two insertion slots for insertion of a plurality of flash memory cards of different interface.
